(19) United States
(12) Patent Application Publication
(10) Pub. No.: US 2006/0256688 A1
(43) Pub. Date: Nov. 16, 2006

(54) Methods and apparatus for shaping mark recorded on media with electromagnetic radiation beam

(76) Inventor: Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/127,958

(22) Filed: May 11, 2005

(51) Int. Cl. G11B 5/09

(52) U.S. Cl. 369/59.11

(57) ABSTRACT

A method is provided for recording an image on a recording medium using an input beam coupled to the electromagnetic radiation source to provide a visible mark on the recording medium. The method comprises shaping the input beam to provide a modified beam have a first dimension in a first direction greater than a second dimension in a second direction, and applying the modified beam to the recording medium to form the visible mark.

### BACKGROUND

Low power lasers are employed to read and write binary data on the data side of media. One typical medium is an optical storage disk, such as a CD, DVD and the like. Typically, various types of binary data are written on the data side of the disk by a laser beam while the disk is rotating. Binary data may be recorded by changing a property of a desired area on the recording media so that the area is indicative of a zero or one data value.

The side of a data disk opposite the data side is often used for handwriting or affixing or marking a label with descriptions and illustrations corresponding to the recorded data. Recently, apparatus and methods have been developed with the ability to generate an optically visible label on the non-data region of an optical disk using the same laser that was employed to read and write digital or electronic data on the data side of the disk. See U.S. Patent Application Publication No. 2003/0108708 (Anderson, et al.), disclosing the use of laser sensitive materials on a disk label that react chemically with the application of light and heat and result in changes in color and shading on the label to form visible marks. As used herein, the terms “spot” or “data spot” refers to a non-visible spot or mark made on the data side of the disk. The terms “mark” or “visible mark” refers to a visible mark or spot made on the label side of the disk.

In making data spots using an optical disk drive, small compact spots are provided extremely close together and usually circular, in order to pack as much data as possible on the disk. The same laser system used to form data spots may be used on the label side to provide visible marks. Hence, visible marks on the label side formed by a data spot recording system are usually small and roughly circular in shape. This shape is advantageous, since the minimum size spot is desired, and since the data media does not require mixing of chemicals to make a mark, it also generally does not limit the speed. For other systems, such as the thermochromic system shown in U.S. Patent Application Publication No. 2003/0108708, the time to mix limits the existing maximum speed of the system, since time is required to heat the media chemicals and mix them in order to form each mark.

The quality of a plurality of visible marks is often determined by measuring optical density (OD), which is a measure of the amount of light absorbed by a marked area. This mark quality or OD must be maintained at a certain minimum standard to provide a desired label quality. However, it is also important to print the label as quickly as possible. To achieve faster print speeds, a higher-powered laser may be used. Although a higher-powered laser may heat and mix the chemicals faster, it also tends to disadvantageously burn the medium and cause ablation above a certain power level for a given spot size. Lower-powered lasers may be used, but the rotational speed of the optical disk must be reduced to allow more time for a laser to heat the medium, thereby disadvantageously increasing the time needed to print a given area. Consequently, it is desirable to be able to increase print speeds, while maintaining a desired optical density of the label.

### SUMMARY OF THE INVENTION

In one embodiment of the present invention, a method is provided for recording an image on a recording medium using an input beam coupled to the electromagnetic radiation source to provide a visible mark on the recording medium. The method comprises shaping the input beam to provide a modified beam having a first dimension in a first direction greater than a second dimension in a second direction, and applying the modified beam to the recording medium to form the visible mark.

### BRIEF DESCRIPTION OF THE DRAWINGS

FIG. 1 is a schematic diagram showing the relative times to heat, mix and react chemicals in a medium, according to an embodiment of the present invention;

FIG. 2A is a schematic drawing of a circular mark;

FIG. 2B is a schematic drawing of an oval shaped mark, according to one embodiment of the invention;

FIG. 3 is a simplified schematic diagram of a laser system according to one embodiment of the present invention;

FIGS. 4A and 4B are schematic diagrams of a series of marks according to an embodiment of the present invention;

FIG. 5A-5C are schematic diagrams showing marks with different dimensions, according to an embodiment of the present invention;

FIG. 6 is a flow diagram showing a method in accordance with an embodiment of the invention; and

FIG. 7 is another flow diagram showing a method in accordance with an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In making marks on a label region, a laser-activated medium may be applied to, or fabricated as part of, the label region. The write process involves applying a laser beam to heat the medium to liquefy chemicals on the medium, mixing the liquefied chemicals together, and reacting the chemicals to provide a visible mark. The step of mixing the chemicals requires much longer than the other steps in the process.

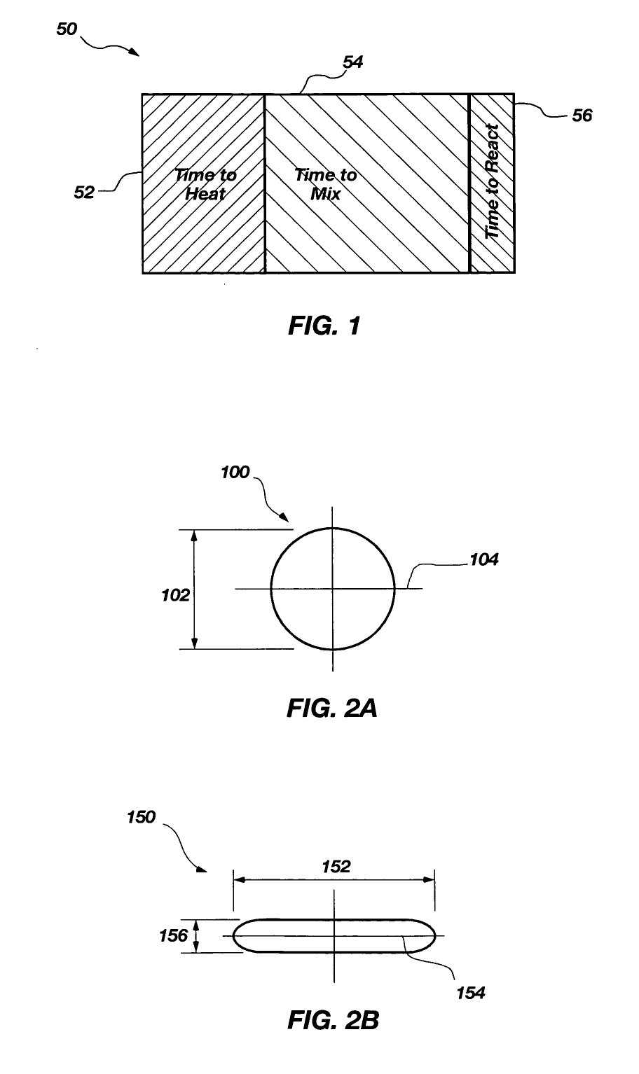

Referring to FIG. 1, a timing graph 50 depicts without quantification the time required to make an acceptable mark, according to the present invention. Time period 52 represents a time during which the recording medium (not shown) is heated to a level at which liquefaction begins. A longer time period 54 represents a time during which the marking materials become sufficiently liquefied so as to mix together. Finally, a shorter time period 56 represents a time during which the mixed marking materials react sufficiently to form a desired optically visible mark. The purpose of the process shown in graph 50 is to form a mark having a certain optical density or predetermined contrast with the unmarked background of the label.

It is apparent from FIG. 1 that most of the time in the mark forming process is taken up with heating and mixing the laser-activated chemicals prior to formation of the mark. Since these preliminary processes are necessary for the formation of each mark, they limit the speed of printing. Accordingly, this invention is concerned with methods and apparatus for increasing the speed of printing by completing the processes of heating and mixing the chemicals in the same amount of time, but at a higher relative linear velocity between the media and the laser.

One way to increase the print speed is to increase the laser power and thereby to heat the media more quickly and to a higher temperature. However, since the media has a thermal limit, such as a maximum of 350° C. temperature, the laser power can only be increased to a maximum amount before the media decomposes or ablates during marking. The linear velocity can only be increased to a limit, since the time to mix is already at a minimum when the media is heated to the maximum allowable temperature. Exceeding the maximum temperature is undesirable, leading to problems with media permanence and particle release when marking.

In one embodiment of the present invention, a mark size of 38 um may be approximately the largest acceptable size for the desired print resolution. This mark size corresponds to a 25400 um/inch/38 um/dot=668 dpi printed image. To increase print speed further and still maintain the desired print resolution while not increasing the media temperature, the shaped spot technique of the present invention can be used. An advantage of shaped spot marking is the ability to use higher laser power with the same media at a higher linear velocity. The media remains under the laser illumination for approximately the same duration, but since the spot is longer along the direction of travel, the linear velocity can be increased. The higher laser power is possible because the maximum fluence, or delivered energy per unit area remains the same for the shaped spot and circular spot, given that the area of the beam increases proportionally with the power used. Since the fluence does not increase, the temperature of the media remains similar for both cases and undesirable effects such as ablation are avoided.

Thus, the beam forming the image is expanded along the axis of travel to provide an oval or elliptical shaped mark. By extending the mark shape in the direction of travel, a higher relative linear velocity can be used to mark a medium while still providing sufficient time of exposure to laser illumination so as to satisfy the requirement of a predetermined amount of time for the chemicals to be heated and mixed. Additionally, the resolution of the print medium is not reduced by this technique. Thus, the printing speed may be substantially increased without detrimentally impacting the quality of labeling or damaging the medium.

FIG. 2A shows a typical shape of a visible mark 100 formed by a laser recording system. The mark 100 is roughly circular, so that the diameter 102 determines the dimension of the mark in the direction of optical disk travel 104. In one embodiment the diameter of the visible mark is 38 microns.

FIG. 2B shows a visible mark 150 according to the present invention. The mark 150 is elongated or oval shaped with the length 152 in the direction of travel 154 being much greater than the width 156 transverse to the direction of travel 154. In one embodiment, the length 152 is 125 microns and the width 156 is 38 microns. Using the embodiment shown in FIG. 2B, the data may be printed over a larger area after the chemicals have been heated and mixed. By making the mark larger, the optical density of the label area may be increased. It is assumed that the laser power is increased approximately proportional to the increase in mark area. A typical power for circular 38 um beam is 110 mW. The corresponding power for a 38 um×125 um oval spot is 363 mW. In this example, the relative linear velocity of the media can be approximately 125 um/38 um=3.3 times as fast as the circular spot example. The power used for the corresponding oval beam can be 110 mW×3.3=363 mW. This approach enables the writing system to operate at higher print speeds while maintaining a desired optical density for the label area.

Laser System

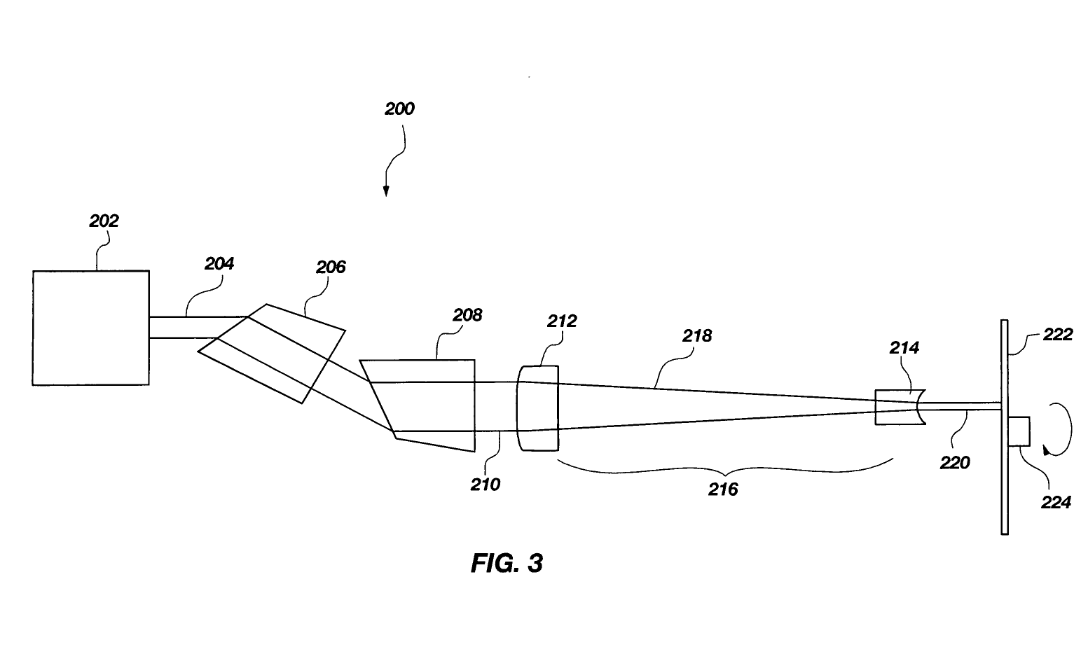

FIG. 3 shows a simplified laser recording system 200 with respect to one embodiment of the invention. A laser unit 202 generates a laser beam 204 that is shaped to change one or more axes of the beam using prisms 206 and 208. The shaped beam 210 is passed through a pair of lenses 212 and 214 that together form a telescope 216 to reduce the beam diameter 218. The shaped and reduced laser beam 220 is applied to an optical disk 222, rotating about a spindle 224.

In one embodiment, laser unit 202 includes a laser that may emit beams having a wavelength of 780 nanometers. The prisms 206 and 208 may be an anamorphic prism pair that shapes the beam by effectively extending the axis in the direction of travel on optical disk 222. This may be done by reducing the beam width while maintaining the same length of the beam. Accordingly, the axis in the direction of travel is effectively longer than the beam width, as shown in FIG. 2. In FIG. 3, the anamorphic prism pair 206 and 208 may be mounted or unmounted prisms from the 870 or 880 series numbers, made by Thor Labs in Newton, N.J. The beam width may be reduced by 3.3 or less relative to the beam length, which is one meridian. Diffraction will tend to increase the smaller axis more than the longer axis, reducing the effective ratio, depending on the scale of the beam and the optics. The telescope pair of lenses 216 may be a plano-convex lens of 2 mm thickness and 10 mm radius for lens 212 and plano-concave lens of 2 mm thickness and 11 mm radius for lens 214.

In a label writing operation, the laser unit 202 may be an infrared diode laser emitting a light beam having a wavelength of about 780 nanometers, in order to effectively interact with chemicals on the medium and cause image marking to take place. A thermochromic marking system may be commonly used. This system uses a media containing a chemical system that induces a permanent or temporary change in the appearance of the media after the media is heated to a certain critical temperature. For one embodiment, the critical temperature is 170 degrees C. A photochromic marking system may also be used. This system uses a media containing a chemical system that induces a permanent or temporary change in the appearance of the media after the media is exposed to light shorter than certain wavelengths.

The present invention may be applied to various recording substrates, including a data recording disk, a DVD, CD, Blu-Ray or HD DVD disk. The recording media on any of the recording substrates may be thermochromic or photochromic recording media.

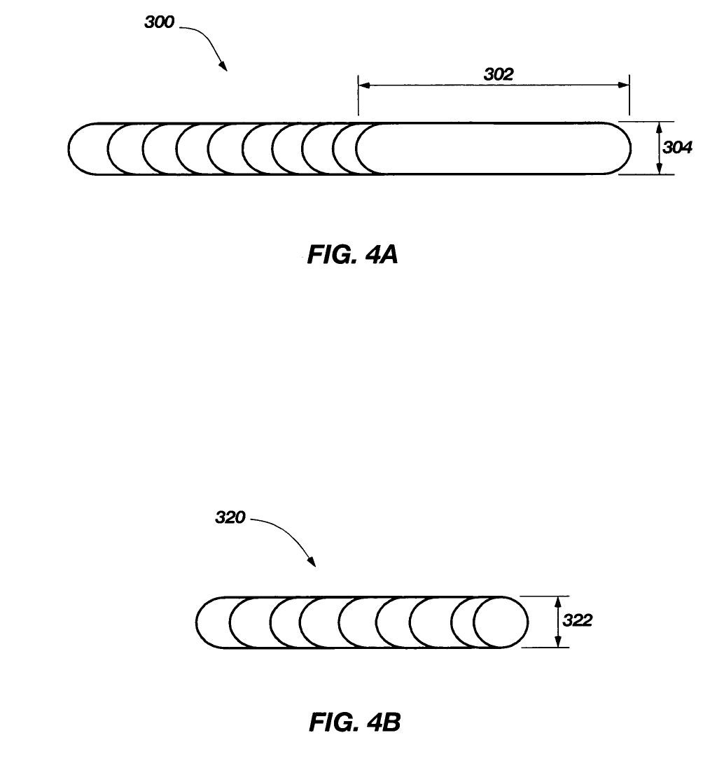

Referring to FIGS. 4A and 4B, the effective increase in length of a series of oval-shaped marks 300 in the direction of travel can be seen in FIG. 4A relative to a series of circular marks 320, shown in FIG. 4B. As shown in FIG. 4A, the length dimension 302 of the marks 300 is 3.3 times the width dimension 304, referred to herein as an aspect ratio of 3.3 to 1. Multiplying the aspect ratio times the rotational speed of an optical disk, i.e. 0.40 meters per second, yields an effective media speed of 1.32 meters per second for the embodiment shown in FIG. 4A.

In FIG. 4B, a series of circular marks 320 is shown, each mark having a diameter 322. Accordingly, the aspect ratio of the marks 320 is 1.0. Multiplying the aspect ratio times the rotational speed of an optical disk, for example 0.40 meters per second yields an effective media speed of 0.40 meters per second. Accordingly, the extended length marks 300, in FIG. 4A enable an increase in print speed of 3.3 times the effective print speed for circular marks 320, shown in FIG. 4B.

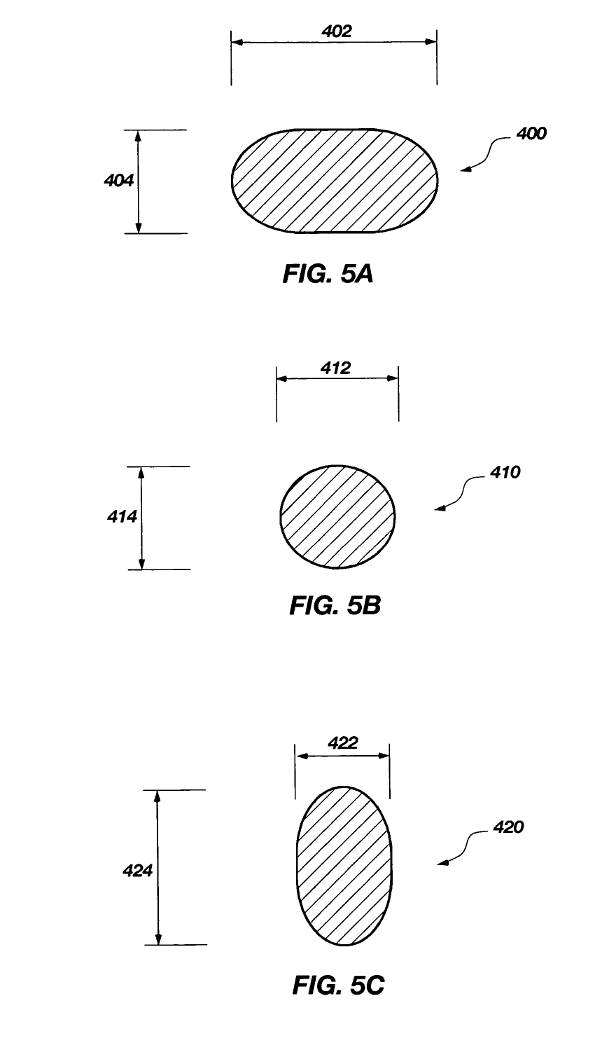

Looking next at FIGS. 5A-5C, three different visible mark configurations are shown according to the present invention. In FIG. 5A, an oval-shaped mark 400 is shown having a longer dimension 402 in the direction of travel and a short dimension 404 in a direction transverse to the direction of travel. This is similar to the oval-shaped marks shown in FIGS. 2B and 4A. FIG. 5B shows a circular mark 410 having a dimension 412 in the direction of travel that is approximately equal to the dimension 414 transverse to the direction of travel.

FIG. 5C shows a different type of oval-shaped mark 420, having a dimension 422 in the direction of travel that is shorter than the dimension transverse to the direction of travel. Mark 420 may be formed by a laser system similar to that shown in FIG. 3, except that the prism pair 206, 208 is rotated 90 degrees from the positions shown in FIG. 3. This prism rotation will cause the light beam to be rotated by 90 degrees, so that the dimension 422 in the direction of travel is shorter than the dimension 424 transverse to the direction of travel. The oval-shaped mark 420 may extend into an adjacent track on the optical disk, so that the marking area effectively cuts down the number of tracks needed to mark a label.

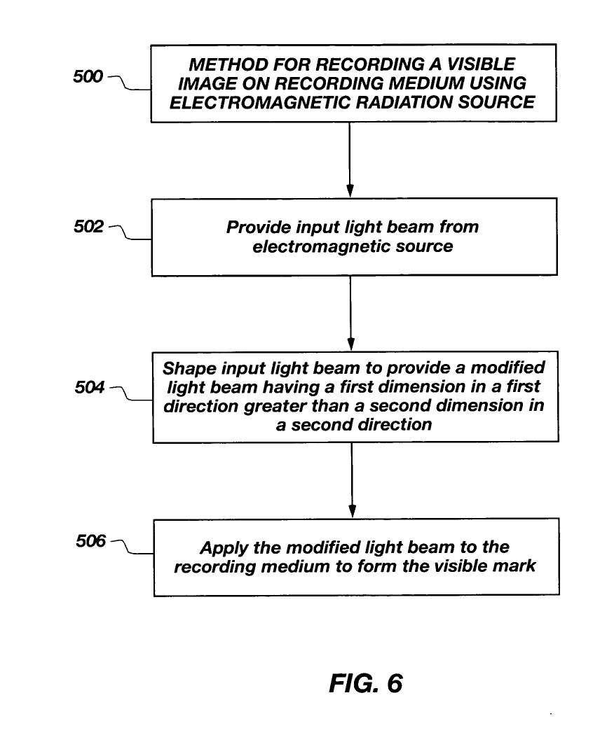

Looking at FIG. 6, a method 500 is provided for recording a visible image on recording medium using an electromagnetic radiation source. At step 502, an input beam is provided from the electromagnetic source. Next, at 504, the input beam is shaped to provide a modified beam having a first dimension in a first direction greater than a second dimension in a second direction. At step 506, the modified beam is applied to the recording medium to form that visible mark.

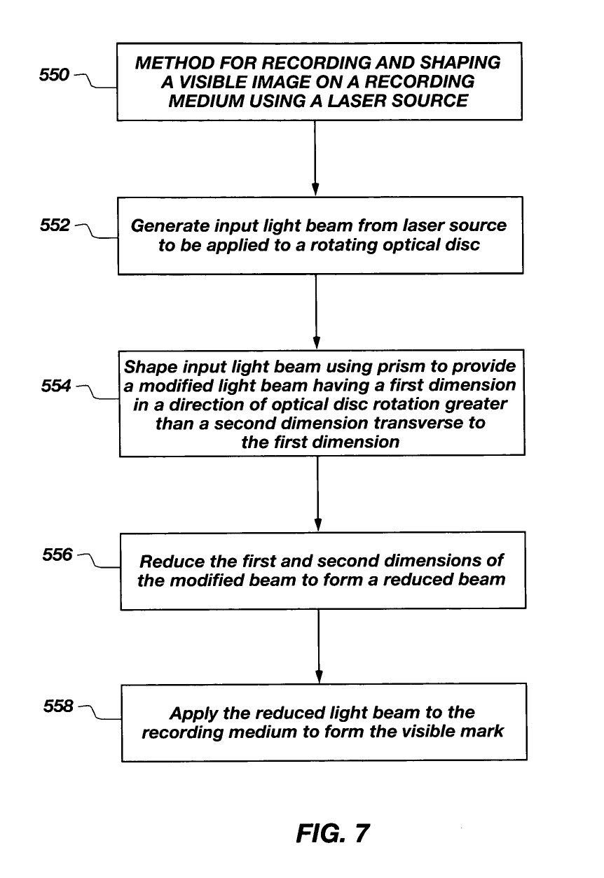

FIG. 7 provides a method 550 for shaping and recording a visible image on a recording medium using a laser source. At step 552, an input laser beam is generated from a laser source, for application to the recording medium on an optical disk. At 554, the input laser beam is shaped using a prism unit to provide a modified light beam having a first dimension in a direction of optical disk rotation that is greater than a second dimension transverse to the first dimension. At step 556, the first and second dimensions of the modified light beam are reduced to form a reduced light beam. Finally, at step 558, the reduced light beam is applied to the recording medium on the rotating optical disk to form the visible image.

It should be understood that the above-referenced arrangements are illustrative of the application for the principles of the present invention. It will be apparent to those of ordinary skill in the art that numerous modifications, such as a mechanism which provides for rectilinear, rather than rotational, movement of the recording medium relative to the electromagnetic beam, or a recording medium substrate other than an optical disc, such as a sheet of plastic or paper media, can be made without departing from the principles and concepts of the invention as set forth in the claims.

What is claimed is:

1. A method for recording an image on a recording medium using an input beam coupled to the electromagnetic radiation source to provide a visible mark on the recording medium, comprising:
(a) shaping the input beam to provide a modified beam having a first dimension in a first direction greater than a second dimension in a second direction; and
(b) applying the modified beam to the recording medium to form the visible mark.

2. The method of claim 1, wherein the visible mark is oval shaped.

3. The method of claim 2, wherein the first dimension of the oval shaped mark is directed in a direction of travel along the recording medium and the second dimension is transverse to the first dimension.

4. The method of claim 2, wherein the second dimension of the oval shaped mark is directed in a direction of travel along the recording medium and the first dimension is transverse to the second dimension.

5. The method of claim 3 wherein the first dimension is substantially greater than the second dimension.

6. The method of claim 1, wherein the shaping the input beam comprises applying the input beam to an anamorphic prism pair.

7. The method of claim 1, further comprising reducing the first and/or second dimensions of the modified beam before applying the modified beam to the recording medium.

8. The method of claim 7, wherein the dimensions of the modified beam are reduced by using a telescopic unit.

9. The method of claim 1, wherein the electromagnetic radiation source is a laser.

10. The method of claim 1 where the recording medium is a thermochromic medium.

11. The method of claim 1 where the recording medium is a photochromic medium.

12. The method of claim 1, wherein the recording medium is disposed on a substrate.

13. The method of claim 12 wherein the substrate is an optical disc.

14. The method of claim 13 wherein the optical disc is one of the following group: DVD, CD, Blu-Ray or HD DVD disks.

15. Apparatus for recording an image on a recording medium using an input beam coupled to the electromagnetic radiation source to provide a visible mark on the recording medium, comprising:
(a) means optically coupled to the electromagnetic radiation source for shaping the input beam to provide a modified beam having a first dimension in a first direction greater than a second dimension in a second direction; and
(b) means optically coupled to the means for shaping the input beam for applying the modified beam to the recording medium to form the visible mark.

16. The apparatus of claim 15, wherein the means for shaping provides a visible mark that is oval shaped.

17. The apparatus of claim 16, wherein the first dimension of the oval shaped mark is directed in a direction of travel along the recording medium and the second dimension is transverse to the first dimension.

18. The apparatus of claim 17, wherein the first dimension is substantially greater than the second dimension.

19. The apparatus of claim 18, further comprising means for reducing the first and/or second dimensions of the modified beam before applying the modified beam to the recording medium.

20. Apparatus for recording an image on a recording medium using an input beam coupled to the electromagnetic radiation source to provide a visible mark on the recording medium, comprising:
(a) a prism device optically coupled to the electromagnetic radiation source and configured to shape the input beam to provide a modified beam having a dimension in a first direction greater than a dimension in a second direction; and
(b) a lens arrangement optically coupled to the prism device and configured to apply the modified beam to the recording medium to form the visible mark.

21. The apparatus of claim 20, wherein the prism device provides a visible mark that is oval shaped.

22. The apparatus of claim 21, wherein the oval shaped mark has a first dimension in a direction of travel substantially greater than a second dimension transverse to the direction of travel.

23. The apparatus of claim 21, wherein the oval shaped mark has a first dimension transverse to a direction of travel substantially greater than a second dimension in the direction of travel.

24. The apparatus of claim 20, wherein the prism device comprises an anamorphic prism pair.

25. The apparatus of claim 24, wherein the anamorphic prism pair comprises a prism pair such that the beam width may be reduced by 3.3 or less relative to the beam length.

26. The apparatus of claim 24, wherein the lens arrangement comprises a telescope optics device configured to reduce the first and/or second dimensions.

27. The apparatus of claim 26, wherein the telescope optics device comprises a plano-convex lens optically coupled with a plano-concave lens.

28. The apparatus of claim 20, wherein the electromagnetic radiation source is a laser.

29. The apparatus of claim 20, wherein the recording medium is an optical disc.

30. A program storage system readable by a computer, tangibly embodying a program, applet or instructions executable by the computer to cause a laser marking system to utilize an input beam from a laser to perform a method for making a visual mark on a recording medium, comprising:
(a) shaping the input beam to provide a modified beam having a first dimension in a first direction greater than a second dimension in a second direction; and
(b) applying the modified beam to the recording medium to form the visible mark.

31. The program storage system of claim 30, wherein the visible mark is oval shaped.

32. The program storage system of claim 30, wherein the first dimension of the oval shaped mark is directed in a direction of travel along the recording medium and the second dimension is transverse to the first dimension.

33. The program storage system of claim 30, wherein the second dimension of the oval shaped mark is directed in a direction of travel along the recording medium and the first dimension is transverse to the second dimension.

34. The program storage system of claim 32 wherein the first dimension is substantially greater than the second dimension.

35. The program storage system of claim 30, further comprising reducing the first and/or second dimensions of the modified beam before applying the modified beam to the recording medium.

36. The program storage system of claim 35, wherein the dimensions of the modified beam are reduced by using a telescopic unit.

37. The program storage system of claim 30, wherein the electromagnetic radiation source is a laser.

38. The program storage system of claim 30, wherein the recording medium is an optical disk.

39. A method of recording a visible mark on an electromagnetic radiation-sensitive recording medium, comprising:
impinging an electromagnetic radiation beam on the recording medium, the beam being elongated in a first direction relative to a second direction orthogonal to the first direction; and
moving at least one of the electromagnetic beam and the recording medium relative to one another in the first direction.

40. The method of claim 39, comprising:
shaping an input beam to form the electromagnetic radiation beam.

41. The method of claim 39, wherein the impinging includes applying the beam to a desired location on the recording medium for a time and at a power level sufficient to heat, mix, and react chemicals of the medium so as to form the visible mark at the desired location.

42. The method of claim 41, wherein the time and the power level are insufficient to ablate the recording medium.

43. The method of claim 39, wherein the impinging includes applying the beam to a desired location on the recording medium at a wavelength sufficiently short so as to form the visible mark at the desired location.

44. The method of claim 39, wherein a speed of the moving is inversely proportional to the amount of elongation of the beam.

45. An apparatus for recording a visible mark on an electromagnetic radiation-sensitive recording medium, comprising:
a source configured to emit an electromagnetic radiation beam;
an optical arrangement configured to elongate the electromagnetic radiation beam in a first direction relative to a second direction orthogonal to the first direction, and impinge the electromagnetic radiation beam on the recording medium; and
a spindle configured to move the recording medium relative to the electromagnetic radiation beam in the first direction.

46. The apparatus of claim 45 wherein the source is a laser.

47. The apparatus of claim 45, wherein the optical arrangement includes a prism device.

48. The apparatus of claim 47, wherein the prism device is an anamorphic prism pair.

49. The apparatus of claim 45, wherein the optical arrangement includes a telescope optics device.

50. The apparatus of claim 49, wherein the telescope optics device is a plano-convex lens optically coupled with a plano-concave lens.
